(19) United States
(12) Patent Application Publication
(10) Pub. No.: US 2014/0079458 A1
(43) Pub. Date: Mar. 20, 2014

(54) SHEET MATERIAL IDENTIFICATION DEVICE AND METHOD, AND IMAGE FORMING APPARATUS

(71) Applicants: Masami SETO, Osaka (JP); Kunihiro Tan, Hyogo (JP); Shinichi Kubota, Osaka (JP); Yoshihiko Miki, Osaka (JP)

(72) Inventors: Masami SETO, Osaka (JP); Kunihiro Tan, Hyogo (JP); Shinichi Kubota, Osaka (JP); Yoshihiko Miki, Osaka (JP)

(73) Assignee: RICOH COMPANY, LTD., Tokyo (JP)

(21) Appl. No.: 13/974,281

(22) Filed: Aug. 23, 2013

(30) Foreign Application Priority Data
Sep. 14, 2012 (JP) 2012-203404

(51) Int. Cl. G03G 15/00; G01N 19/10

(52) U.S. Cl. CPC G03G 21/203; G01N 19/10
USPC 399/389; 73/29.02; 399/390

(57) ABSTRACT

A sheet material identification device includes a humidity adjuster, a detector, and a controller. The humidity adjuster adjusts the humidity of a sheet material by causing the sheet material to either release or absorb moisture. The detector detects the humidity of the sheet material before and after the adjustment of the humidity. The controller calculates a first difference in humidity of the sheet material before and after the adjustment of the humidity, and identifies the type of sheet material on the basis of the first difference.

### CROSS-REFERENCE TO RELATED APPLICATION

This patent application is based on and claims priority pursuant to 35 U.S.C. §119 to Japanese Patent Application No. 2012-203404, filed on Sep. 14, 2012, in the Japan Patent Office, the entire disclosure of which is hereby incorporated by reference herein.

### BACKGROUND

1. Technical Field

The present invention relates to a sheet material identification device and a sheet material identification method which identify the type of a sheet material used in, for example, a copier or a printer, and an image forming apparatus using the sheet material identification device.

2. Related Art

In an electrophotographic image forming apparatus, such as a copier, a printer, a facsimile machine, or a multifunction machine combining the functions of these apparatuses, a toner image formed on a photoconductor drum is first transferred to a sheet or a recording material (hereinafter referred to as the sheet material) by a transfer device. Then, the unfixed toner image is fixed on the sheet material by a fixing device of the image forming apparatus and output (i.e., discharged) from the image forming apparatus. In this process, the moisture content of the sheet material, to which the toner image is transferred, changes depending on the environment (e.g., temperature and humidity) of the interior and surroundings of the image forming apparatus. To obtain a high-definition toner image, therefore, it is desirable to control image forming conditions (e.g., transfer bias and fixing temperature) in accordance with the moisture content of the sheet material. It is also desirable to control the feeding speed of the sheet material in accordance with the moisture content of the sheet material to prevent a feeding failure.

Some of sheet materials of recent years used in image forming apparatuses have surfaces coated with some agent or subjected to special treatment to improve the image quality. It is difficult to accurately detect the moisture content of such a special sheet material without identifying the type of sheet material. Erroneous detection of the moisture content may result in erroneous correction of image forming conditions for forming an image on the special sheet material. As a result, sheet materials for use in image forming apparatuses are limited.

To improve the image quality, the image forming apparatus may be configured to include a humidity sensor, a holding electrode, and a controller. In this image forming apparatus, the humidity sensor is disposed near a surface of a sheet material to face the surface, and the holding electrode is disposed downstream of a transfer roller and upstream of a fixing device in the feeding direction of the sheet material. The holding electrode supplies a bias potential to a surface of the sheet material not facing the transfer roller, to thereby hold a toner image transferred to the sheet material. The controller calculates the moisture content of the sheet material on the basis of the time from the start of a change in humidity detected by the humidity sensor to the peak of the change and the peak value of the change in humidity (i.e., the time during which the sheet material passes a position facing the humidity sensor and the amount of change in humidity detected by the humidity sensor during the time), and controls various bias potentials in accordance with the moisture content.

If the thus-configured image forming apparatus does not identify the type of sheet material, however, the moisture content of the sheet material is not accurately detected, and a control of image forming conditions according to the type of sheet material is prevented.

### SUMMARY

It is an object of the present invention to provide a sheet material identification device, a sheet material identification method, and an image forming apparatus including the sheet material identification device capable of accurately identifying the type of sheet material.

The present invention provides a sheet material identification device that, in one example, includes a humidity adjuster, a detector, and a controller. The humidity adjuster adjusts the humidity of a sheet material by causing the sheet material to either release or absorb moisture. The detector detects the humidity of the sheet material before and after the adjustment of the humidity. The controller calculates a first difference in humidity of the sheet material before and after the adjustment of the humidity, and identifies the type of sheet material on the basis of the first difference.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1 is a diagram illustrating an image forming apparatus according to a first embodiment of the present invention;

FIG. 2 is a diagram illustrating a humidity sensor of the image forming apparatus in FIG. 1;

FIG. 3 is a block diagram illustrating a sheet material identification device according to the first embodiment;

FIG. 4 is a graph illustrating changes over time in sensor output of a detector of FIG. 3 when detecting sheet materials of plain paper;

FIG. 5 is a graph illustrating changes over time in sensor output of the detector of FIG. 3 when detecting sheet materials of special paper;

FIG. 6 is a graph illustrating the relationship between the number of thermal fixing operations executed by a fixing roller of the image forming apparatus in FIG. 1 and the moisture content of the sheet material;

FIG. 7 is a graph illustrating the relationship between the time of passage of the sheet material through the humidity sensor of the detector in FIG. 3 and the change in sensor output;

FIG. 8 is a graph illustrating sensor outputs of the detector in FIG. 3 when detecting sheet materials of plain paper, special paper, and another type of special paper adjusted to different humidity values;

FIG. 9 is a flowchart illustrating a sheet material type identification process executed by the sheet material identification device according to the first embodiment;

FIG. 10 is a diagram illustrating a table for the sheet material type identification process stored in a memory of FIG. 3;

FIG. 11 is a flowchart illustrating a sheet material type identification process and an image forming condition correction process executed by the sheet material identification device according to a second embodiment of the present invention;

FIG. 12 is a diagram illustrating a table for the process of FIG. 11;

FIG. 13 is a diagram illustrating a table for a sheet material type identification process and an image forming condition correction process executed by the sheet material identification device according to a modified example of the second embodiment;

FIG. 14 is a graph illustrating changes over time in sensor output of the detector in FIG. 3 when detecting different surfaces of a sheet material of plain paper in a third embodiment of the present invention;

FIG. 15 is a graph illustrating changes over time in sensor output of the detector n FIG. 3 when detecting different surfaces of a sheet material of special paper in the third embodiment;

FIG. 16 is a graph illustrating changes over time in sensor output of the detector in FIG. 3 when detecting different surfaces of a sheet material of another type of special paper in the third embodiment;

FIG. 17 is a graph illustrating changes in sensor output of the detector in FIG. 3 when detecting different surfaces of sheet materials of plain paper, special paper, and another type of special paper in the third embodiment;

FIG. 18 is diagram illustrating the change in humidity on a printed surface and a rear surface of the sheet material in the third embodiment;

FIG. 19 is a flowchart illustrating a sheet material type identification process and an image forming condition correction process executed by the sheet material identification device according to the third embodiment;

FIG. 20 is a diagram illustrating a table for the process of FIG. 19;

FIG. 21 is a diagram illustrating a table of identification criteria for the table of FIG. 20;

FIG. 22 is a diagram illustrating a table of a sheet material type identification process and an image forming condition correction process executed by the sheet material identification device according to a modified example of the third embodiment; and

FIG. 23 is a diagram illustrating a table of identification criteria for the table of FIG. 22.

### DETAILED DESCRIPTION

In describing the embodiments illustrated in the drawings, specific terminology is adopted for the purpose of clarity. However, the disclosure of the present invention is not intended to be limited to the specific terminology so used, and it is to be understood that substitutions for each specific element can include any technical equivalents that have the same function, operate in a similar manner, and achieve a similar result.

Referring now to the drawings, wherein like reference numerals designate identical or corresponding parts throughout the several views, a first embodiment of the present invention will be described.

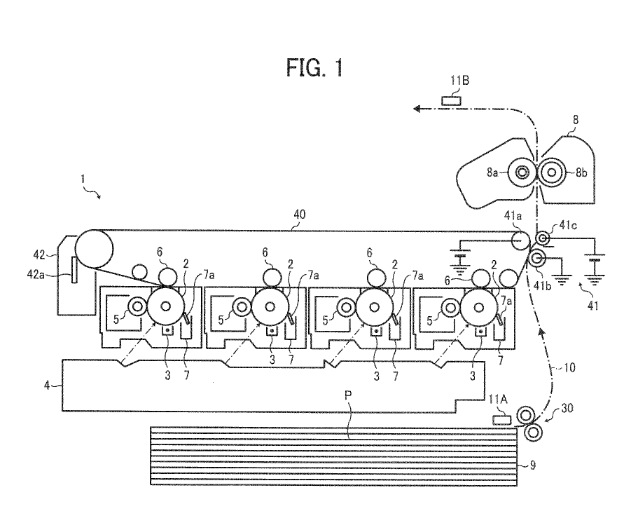

FIG. 1 is a diagram illustrating an image forming apparatus 1 according to the first embodiment of the present invention. As illustrated in FIG. 1, the image forming apparatus 1 includes a secondary transfer mechanism, and may be an electrophotographic copier, for example. The image forming apparatus 1 includes an image forming mechanism that forms an image on a sheet material (i.e., recording medium). The image forming mechanism includes a writing device (i.e., exposure device) 4, photoconductor drums 2, charging devices 3, development devices 5, primary transfer devices 6, cleaning devices 7, an endless transfer belt 40, a secondary transfer device 41, a cleaning device 42, a fixing device 8, a sheet feed cassette 9, a registration roller pair 30, and a sheet feed path 10. The image forming apparatus 1 further includes humidity sensors 11A and 11B.

In the present embodiment, four photoconductor drums 2 serving as image carriers are provided for forming toner images of cyan, yellow, magenta, and black colors, and each of the photoconductor drums 12 is surrounded by the charging device 3, the writing device 4, the development device 5, the primary transfer device 6, and the cleaning device 7 including a cleaning blade 7a.

The transfer belt 40 serving as a transfer member is disposed in contact with the photoconductor drums 2. The secondary transfer device 41 is disposed upstream of the cleaning device 42 in the rotation direction of the transfer belt 40. The secondary transfer device 41 includes transfer rollers 41a and 41b and a holding roller 41c. The cleaning device 42 includes a cleaning blade 42a. The fixing device 8 is disposed above the secondary transfer device 41, and includes a fixing roller 8a and a pressure roller 8b.

The sheet feed cassette 9 stores a stack of sheet materials P. A sheet material P is fed from the sheet feed cassette 9 and discharged outside the image forming apparatus 1 via the registration roller pair 30, the sheet feed path 10, the secondary transfer device 41, and the fixing device 8. The humidity sensor 11A is disposed near the registration roller pair 30 and an upper portion of the sheet feed cassette 9. The humidity sensor 11 B is disposed near the sheet material P discharged from the fixing device 8.

The sheet material P is fed from the sheet feed cassette 9 to the secondary transfer device 41 through the sheet feed path 10 with predetermined timing. Toner images carried on the transfer belt 40 are superimposed and transferred onto the sheet material P by the secondary transfer device 41. The sheet material P having the toner images transferred thereto is fed to the fixing device 8 located downstream of the secondary transfer device 41 in the sheet material feeding direction. The sheet material P is subjected to heat and pressure between the fixing roller 8a and the pressure roller 8b, to thereby fix the toner images on the sheet material P. The sheet material P having the toner images fixed thereon is discharged outside the image forming apparatus 1 by not-illustrated discharge rollers.

Toners not transferred to the transfer belt 40 and remaining on respective surfaces of the photoconductor drums 2 are removed by the cleaning blades 7a of the cleaning devices 7, to thereby prepare the surfaces of the photoconductor drums 2 for the next image forming operation. Similarly, toners not transferred to the sheet material P and remaining on a surface of the transfer belt 40 are removed by the cleaning blade 42a of the cleaning device 42, to thereby prepare the surface of the transfer belt 40 for the next image forming operation.

The humidity sensor 11A detects the humidity of the sheet material P fed from the sheet feed cassette 9 and not subjected to humidity adjustment such as heating by the fixing roller 8a, for example. The humidity sensor 11B detects the humidity of the sheet material P subjected to humidity adjustment such as heating by the fixing roller 8a, for example.

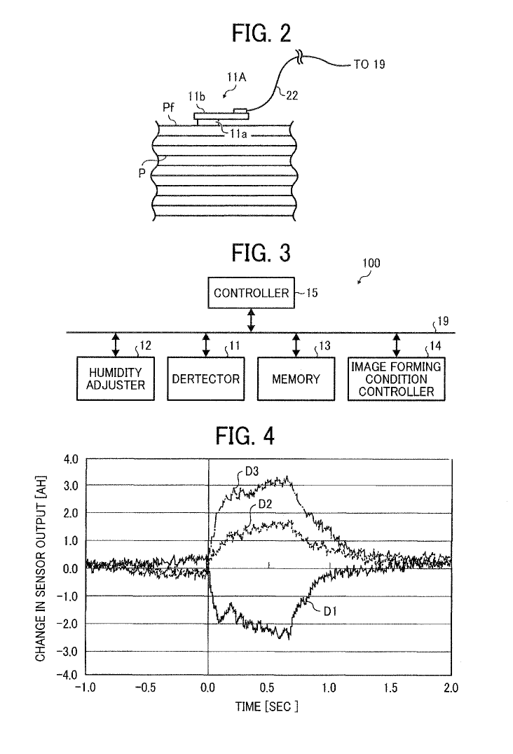

FIG. 2 is a diagram illustrating the humidity sensor 11A of FIG. 1. As illustrated in FIG. 2, the humidity sensor 11A includes a sensor portion 11a and a substrate portion 11b. The sensor portion 11a detects the humidity of the sheet material P, and is electrically connected to the substrate portion 11b. The substrate portion 11b is electrically connected to a control line 19 via a signal line 22.

The sensor portion 11a includes, for example, a heat conduction-type humidity sensor employing microelectromechanical system (MEMS) technology. The type of substrate portion 11b is not limited as long as the substrate portion 11b is capable of fixing the sensor portion 11a thereto and extracting electrical signals from the sensor portion 11a. Preferably, the substrate portion 11b includes, for example, an electronic circuit board made of a glass epoxy material or the like. The sensor portion 11a is bonded to the substrate portion 11b and connected thereto by not-illustrated micro metal wires to be electrically connected to the control line 19 via the signal line 22.

It is preferable to dispose the sensor portion 11a as close to a front surface Pf of the sheet material P as possible. It is also preferable to configure the sensor portion 11a not to accumulate therein foreign substances such as paper dust during repeated feeding of sheet materials P to prevent a reduction in output and response speed of the sensor portion 11a. Therefore, the sensor portion 11a according to the first embodiment of the present invention includes a moisture-permeable film covering a surface of a package of the sensor portion 11a. The sensor portion 11a is disposed immediately in front of the registration roller pair 30 with little gap formed between a surface of the moisture-permeable film and a surface of a carriage of sheet materials P. With this configuration, the sensor portion 11a senses a flow of moisture from the sheet material P faster than the other components of the humidity sensor 11A such as the substrate portion 11b, and thus is capable of appropriately detecting the movement of moisture between the sheet material P and the ambient environment without interference from the other components of the humidity sensor 11A.

Further, since the sensor portion 11a is manufactured using MEMS technology, it is possible to reduce the size of the sensor portion 11a to the order of a few millimeters. Accordingly, it is possible to reduce the humidity sensor 11A in size to enable it to be installed in a relatively small space. The humidity sensor 11B is basically similar in configuration to the humidity sensor 11A.

FIG. 3 is a block diagram illustrating a sheet material identification device 100 according to the first embodiment of the present invention. As illustrated in FIG. 3, the sheet material identification device 100 according to the first embodiment includes a detector 11, a humidity adjuster 12, a memory 13, an image forming condition controller 14, and a controller 15 electrically connected to one another by the control line 19.

The detector 11 includes the above-described humidity sensors 11A and 11B to detect the humidity of the sheet material P before and after the humidity adjustment of the sheet material P, in which the sheet material P is caused to release or absorb moisture. The humidity adjuster 12 adjusts the humidity of the sheet material P. The humidity adjuster 12 includes, for example, the fixing roller 8a that heats the sheet material P to thereby release moisture from the sheet material P and adjust the humidity of the sheet material P. Alternatively, the humidity adjuster 12 is not limited to a heater such as the fixing roller 8a, and may be a dryer that dries the sheet material P to thereby cause the sheet material P to release moisture or a humidifier that humidifies the sheet material P to thereby cause the sheet material P to absorb moisture. The memory 13 stores a predetermined table representing the relationship between image forming conditions and identification criteria for identifying the type of sheet material P on the basis of the change in humidity of the sheet material P. The image forming condition controller 14 is controlled by the controller 15 to correct predetermined image forming conditions. The controller 15, which controls the overall operation of the sheet material identification device 100, calculates the difference in humidity of the sheet material P before and after the humidity adjustment, and identifies the type of sheet material P on the basis of the calculated difference. The operations of the above-described units will be described in detail later.

FIG. 4 is a graph illustrating changes over time in sensor output of the detector 11 in FIG. 3 when detecting sheet materials P of plain paper (i.e., commercially available paper commonly used for copying, printing, or the like). More specifically, FIG. 4 illustrates outputs of the humidity sensor 11A of the detector 11, which is disposed at a position separated from the sheet material P by approximately 0.5 mm, when detecting sheet materials P moved at a linear velocity of approximately 300 mm/sec in an environment with a temperature of approximately 23° C. and humidity of approximately 50% RH (i.e., room humidity). The heat conduction-type humidity sensor 11A has a micro heater structure, for example. A heat conduction-type humidity sensor including a micro heater is highly responsive to a change in humidity. In FIG. 4, AH represents the absolute humidity, and the change in sensor output of the detector 11 corresponds to the voltage output detected by the detector 11 and converted on the basis of a configuration table stored in, for example, the memory 13. Further, a solid line corresponding to a time of approximately 0.0 seconds represents the time of arrival of the sheet material P at the humidity sensor 11A. The same applies to subsequent graphs.

In FIG. 4, a sensor output D1 indicated by a solid line is the output of the detector 11 when detecting an A4-size sheet material P of plain paper adjusted to humidity of approximately 11% RH with respect to the mean absolute humidity. A sensor output D2 indicated by a clashed line is the output of the detector 11 when detecting an A4-size sheet material P of plain paper adjusted to humidity of approximately 60% RH with respect to the mean absolute humidity. A sensor output D3 indicated by a dash-dotted line is the output of the detector 11 when detecting an A4-size sheet material P of plain paper adjusted to humidity of approximately 75% RH with respect to the mean absolute humidity. As illustrated in FIG. 4, the sensor outputs D2 and D3 each corresponding to the sheet material P of plain paper adjusted to humidity higher than the humidity of the ambient environment are increased after the arrival of the sheet material P at the humidity sensor 11A, i.e., the humidity is increased. The sensor output D1 corresponding to the sheet material P of plain paper adjusted to humidity lower than the humidity of the ambient environment is reduced after the arrival of the sheet material P at the humidity sensor 11A, i.e., the humidity is reduced. After the passage of the sheet material P through the humidity sensor 11A, each of the sensor outputs D1, D2, and D3 returns to the original value according to the humidity of the ambient environment.

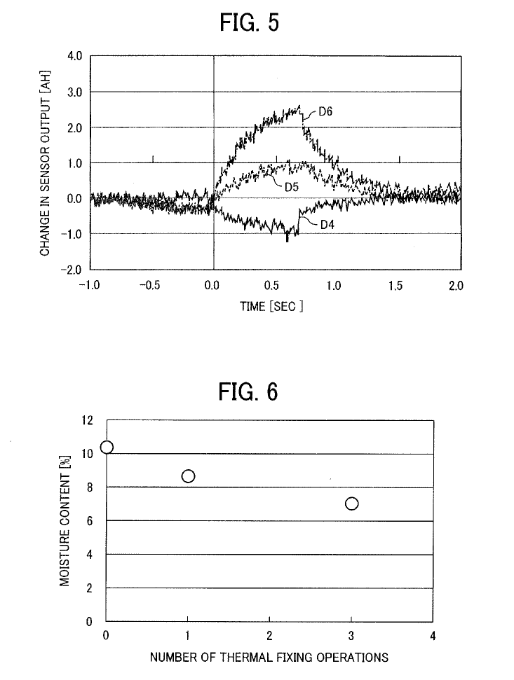

FIG. 5 is a graph illustrating changes over time in sensor output of the detector 11 in FIG. 3 when detecting sheet materials P of special paper. FIG. 5 illustrates the results of sheet materials P of special paper higher in air permeability than the sheet materials P of plain paper in FIG. 4. The other conditions such as the environment are similar to those of FIG. 4. In FIG. 5, a sensor output D4 indicated by a solid line is the output of the detector 11 when detecting an A4-size sheet material P of special paper adjusted to humidity of approximately 11% RH with respect to the mean absolute humidity. A sensor output D5 indicated by a dashed line is the output of the detector 11 when detecting an A4-size sheet material P of special paper adjusted to humidity of approximately 60% RH with respect to the mean absolute humidity. A sensor output D6 indicated by a dash-dotted line is the output of the detector 11 when detecting an A4-size sheet material of special paper adjusted to humidity of approximately 75% RH with respect to the mean absolute humidity.

As illustrated in FIG. 5, the sensor outputs D5 and D6 each corresponding to the sheet material P of special paper adjusted to humidity higher than the humidity of the ambient environment are increased after the arrival of the sheet material P at the humidity sensor 11A, i.e., the humidity is increased. The sensor output D4 corresponding to the sheet material P of special paper adjusted to humidity lower than the humidity of the ambient environment is reduced after the arrival of the sheet material P at the humidity sensor 11A, i.e., the humidity is reduced. After the passage of the sheet material P through the humidity sensor 11A, each of the sensor outputs D4, D5, and D6 returns to the original value according to the humidity of the ambient environment.

As illustrated by the sensor outputs D1 to D6 of FIGS. 4 and 5, the response speed and the peak value are different between the sensor outputs D1 to D3 and the sensor outputs D4 to D6 depending on the type of sheet material P, i.e., plain paper or special paper, even if the sheet materials P are adjusted in humidity under the same environment. Each of the sheet materials P of FIGS. 4 and 5 is adjusted in humidity in a desiccator maintained at constant humidity by saturated brine. For example, lithium chloride (LiCl) is used as saturated brine to adjust the humidity of plain paper to approximately 11% RH, and sodium bromide (NaBr) is used as saturated brine to adjust the humidity of plain paper to approximately 60% RH. Further, for example, sodium chloride (NaCl) is used as saturated brine to adjust the humidity of plain paper to approximately 75% RH. As indicated by the list of P-series (i.e., pulp and paper) of the Japanese Industrial Standards, there are varieties of items expressing properties or qualities of sheet material. Herein, the type of sheet material P is identified on the basis of moisture absorption or moisture release of the sheet material P.

The results illustrated in FIGS. 4 and 5 are obtained from the sheet materials P each placed in an environment for adjusting the humidity of the sheet material P to a constant value. Particularly, to increase the humidity of a sheet material P, the sheet material P is left in a gas higher in moisture content than the ambient environment, i.e., in an environment with relatively high humidity. For example, to increase the humidity of a sheet material P, the sheet material P may be placed in a desiccator containing saturated brine of sodium chloride (NaCl), as described above.

FIG. 6 is a graph illustrating the relationship between the number of thermal fixing operations executed by the fixing roller 8a of FIG. 1 and the moisture content of the sheet material P. FIG. 6 illustrates the moisture contents of the sheet material P of special paper measured by a moisture meter manufactured by Kett Electric Laboratory after three thermal fixing operations, in which the sheet material P of special paper is passed through the fixing roller 8a at a linear velocity of approximately 630 mm/sec to heat the sheet material P at a temperature of approximately 160° C. As illustrated in FIG. 6, the number of operations of heating the sheet material P is proportional to the amount of moisture released from the sheet material P, i.e., the reduction in moisture content (%) of the sheet material P. Therefore, the humidity of the sheet material P is adjusted to a lower value. The sheet material P may be dried without being heated. For example, the sheet material P may be placed in a desiccator containing saturated brine of lithium chloride (LiCl) described above. Alternatively, dry air may be blown at the sheet material P for a predetermined time.

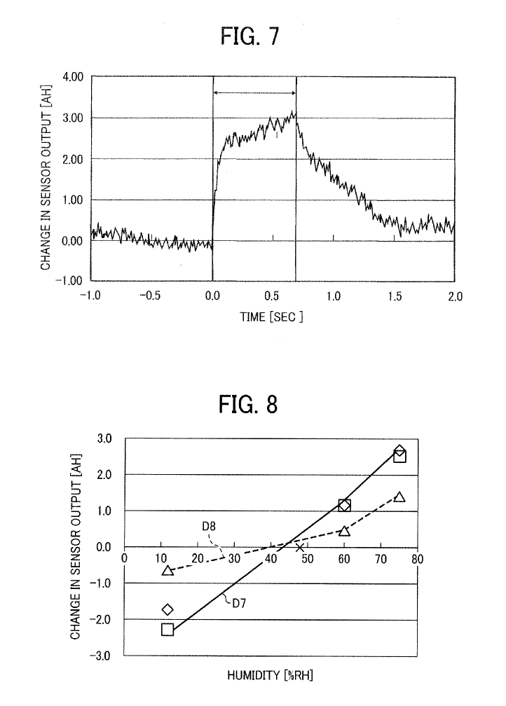

FIG. 7 is a graph illustrating the relationship between the time of passage of the sheet material P through the humidity sensor 11A of the detector 11 in FIG. 3 and the change in sensor output. As described above, the heat conduction-type humidity sensor 11A of the detector 11 in FIG. 3. which uses the thermal conductivity of gases, is highly responsive and reliable. The humidity sensor 11A using the difference in thermal conductivity between gases detects the humidity from the difference in resistance value between resistors caused by the difference in heat amount released from the heated resistors to the atmosphere. FIG. 7 illustrates the change in sensor output of the detector 11 using the heat conduction-type humidity sensor 11A when detecting the humidity near an A4-size sheet material P of plain paper adjusted to humidity of approximately 75% RH and moved at a linear velocity of approximately 300 mm/sec in the short side direction of the sheet material P. In FIG. 7, the time from the arrival of the sheet material P at the humidity sensor 11A to the peak of the change in sensor output indicated by a double-headed arrow is relatively short. As illustrated in FIG. 7, therefore, the humidity of the moving sheet material P is reliably detected by the use of the heat conduction-type humidity sensor 11A highly responsive to the change in absolute humidity.

FIG. 8 is a graph illustrating sensor outputs of the detector 11 in FIG. 3 when detecting sheet materials P of plain paper, special paper A, and special paper B adjusted to different humidity values. In FIG. 8, rhombic marks represent the results of plain paper, and square marks represent the results of special paper A. Further, triangular marks represent the results of special paper B, and a cross mark represents the humidity of the ambient environment. In FIG. 8, a sensor output D7 indicated by a solid line represents the change in output of the detector 11 when detecting sheet materials P of plain paper and sheet materials P of special paper A respectively adjusted to humidity values of approximately 11% RH, approximately 60% RH, and approximately 75% RH. A sensor output D8 indicated by a dashed line represents the change in output of the detector 11 when detecting sheet materials P of special paper B adjusted to humidity values of approximately 11% RH, approximately 60% RH, and approximately 75% RH. As illustrated in FIG. 8, the change in output of the detector 11 is different among the different types of the sheet materials P, even if the sheet materials P are adjusted to the same humidity values of approximately 11% RH, approximately 60% RH, and approximately 75% RH.

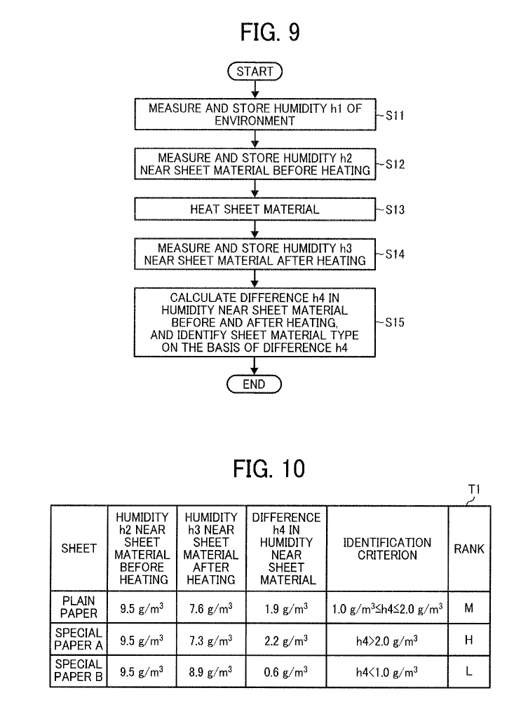

FIG. 9 is a flowchart illustrating a sheet material type identification process executed by the sheet material identification device 100 according to the first embodiment of the present invention. At step S11 of FIG. 9, the controller 15 causes the detector 11 to measure humidity h1 of the environment inside the image forming apparatus 1 and store the measured humidity h1 in the memory 13. Then, at step S12, the controller 15 causes the detector 11 to measure humidity h2 near the sheet material P before heating and store the measured humidity h2 in the memory 13. In the first embodiment, the type of sheet material P is identified on the basis of the difference between the humidity h2 near the sheet material P before heating and humidity h3 near the sheet material P after heating, as described later. This is because the humidity h1 of the environment and the humidity h2 near the sheet material P before heating are substantially equal in most cases. However, the difference between the humidity h2 near the sheet material P before heating and the humidity h1 of the environment may he calculated as necessary.

Then, at step S13, the controller 15 causes the humidity adjuster 12 to heat the sheet material P by using, for example, the fixing roller 8a. At step S14, the controller 15 causes the detector 11 to measure the humidity h3 near the sheet material P after heating and store the humidity h3 in the memory 13. At step S15, the controller 15 calculates a difference h4 in humidity near the sheet material P before and after the heating (i.e., first difference), and identifies the type of sheet material P on the basis of the difference h4. More specifically, at step S15, the controller 15 identifies the type of sheet material P by referring to a predetermined table T1 stored in the memory 13.

FIG. 10 is a diagram illustrating the table T1 for the sheet material type identification process stored in the memory 13 of FIG. 3. As illustrated in FIG. 10, in the case of the sheet material P of plain paper, the humidity h2 near the sheet material P before heating is approximately 9.5 g/m³, and the humidity h3 near the sheet material P after heating is approximately 7.6 g/m³. Therefore, the difference h4 in humidity near the sheet material P before and after the heating is approximately 1.9 g/m³. With reference to the identification criteria of the table T1, in which the difference h4 of approximately 1.9 g/m³ falls in a range of from approximately 1.0 g/m³ to approximately 2.0 g/m³, the controller 15 identifies the sheet material P as plain paper.

Similarly, in the case of the sheet material P of special paper A, the humidity h2 near the sheet material P before heating is approximately 9.5 g/m³, and the humidity h3 near the sheet material P after heating is approximately 7.3 g/m³. Therefore, the difference h4 in humidity near the sheet material P before and after the heating is approximately 2.2 g/m³. With reference to the identification criteria of the table T1, in which the difference h4 of approximately 2.2 g/m³ falls in a range greater than approximately 2.0 g/m³, the controller 15 identifies the sheet material P as special paper A (e.g., coated paper with relatively low air permeability).

Similarly, in the case of the sheet material P of special paper B, the humidity h2 near the sheet material P before heating is approximately 9.5 g/m³, and the humidity h3 near the sheet material P after heating is approximately 8.9 g/m³. Therefore, the difference h4 in humidity near the sheet material P before and after the heating is approximately 0.6 g/m³. With reference to the identification criteria of the table T1, in which the difference h4 of approximately 0.6 g/m³ falls in a range less than approximately 1.0 g/m³, the controller 15 identifies the sheet material P as special paper B (e.g., coated paper with relatively high air permeability).

As described above, the sheet material identification device 100 according to the first embodiment is capable of accurately identifying the type of sheet material P by causing the detector 11 to detect the moisture amount absorbed or released by the sheet material P after the humidity adjustment by the humidity adjuster 12. Further, the sheet material identification device 100 according to the first embodiment, which is capable of identifying the type of sheet material P, is capable of accurately detecting the moisture content of the sheet material P.

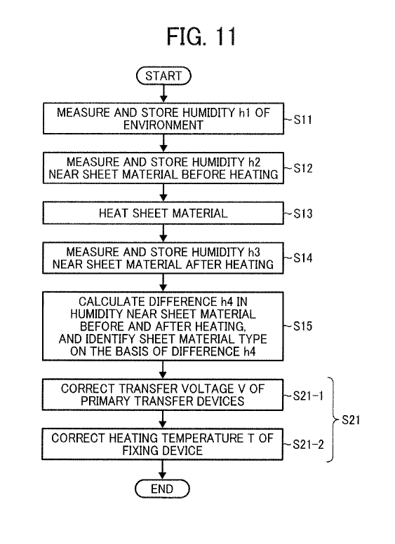

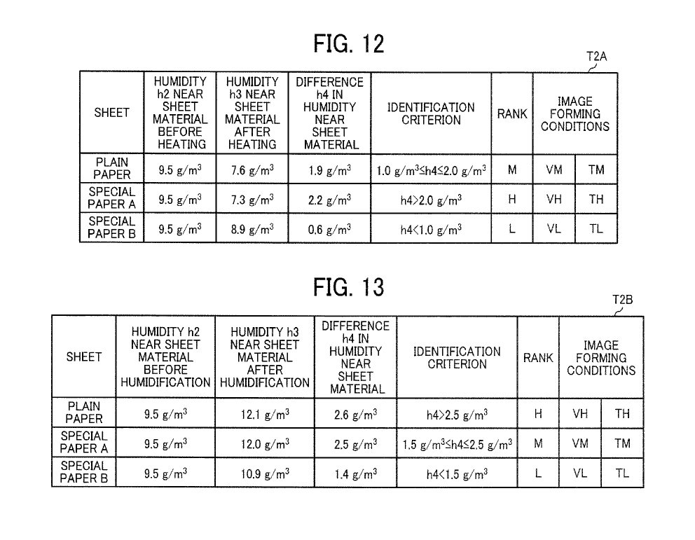

A second embodiment of the present invention will now be described. FIG. 11 is a flowchart illustrating a sheet material type identification process and an image forming condition correction process executed by the sheet material identification device 100 according to the second embodiment. FIG. 12 is a diagram illustrating a table T2A for the process of FIG. 11. As illustrated in FIG. 11, in addition to the sheet material type identification process according to the first embodiment, the second embodiment further performs an image forming condition correction process (step S21). In this process, the controller 15 corrects a transfer voltage V of the primary transfer devices 6 and a heating temperature T of the fixing device 8 on the basis of the type of sheet material P identified at step S15.

At step S21-1 of FIG. 11, the controller 15 corrects the transfer voltage V of the primary transfer devices 6 on the basis of the identified type of the sheet material P. If the sheet material P is identified as plain paper, for example, the controller 15 refers to the table T2A stored in the memory 13 and corrects the transfer voltage V of the primary transfer devices 6 to a transfer voltage VM suitable for plain paper, as illustrated in FIG. 12. Similarly, if the sheet material P is identified as special paper A, the controller 15 refers to the table T2A stored in the memory 13 and corrects the transfer voltage V of the primary transfer devices 6 to a transfer voltage VH higher than the transfer voltage VM and suitable for special paper A. Similarly, if the sheet material P is identified as special paper B, the controller 15 refers to the table T2A stored in the memory 13 and corrects the transfer voltage V of the primary transfer devices 6 to a transfer voltage VL lower than the transfer voltage VM and suitable for special paper B.

Further, at step S21-2, the controller 15 corrects the heating temperature T of the fixing device 8 on the basis of the identified type of the sheet material P. If the sheet material P is identified as plain paper, for example, the controller 15 refers to the table T2A stored in the memory 13 and corrects the heating temperature T of the fixing device 8 to a heating temperature TM suitable for plain paper. Similarly, if the sheet material P is identified as special paper A, the controller 15 refers to the table T2A stored in the memory 13 and corrects the heating temperature T of the fixing device 8 to a heating temperature TH higher than the heating temperature TM and suitable for special paper A. Similarly, if the sheet material P is identified as special paper B, the controller 15 refers to the table T2A stored in the memory 13 and corrects the heating temperature T of the fixing device 8 to a heating temperature TL lower than the heating temperature TM and suitable for special paper B.

As described above, according to the sheet material type identification process and the image forming condition correction process executed by the sheet material identification device 100 according to the second embodiment, the image forming condition correction process is further performed on the basis of the identified type of the sheet material P. For example, at step S21-1, the controller 15 corrects the transfer voltage V of the primary transfer devices 6 on the basis of the identified type of the sheet material P. Then, at step S21-2, the controller 15 corrects the heating temperature T of the fixing device 8 on the basis of the identified type of the sheet material P. The second embodiment thus allows control of image forming conditions according to the type of sheet material P (e.g., plain paper, special paper A, or special paper B), and therefore further improves the quality of the image transferred to the sheet material P.

FIG. 13 is a diagram illustrating a table T2B for a sheet material type identification process and an image forming condition correction process executed by the sheet material identification device 100 according to a modified example of the second embodiment. As illustrated in FIG. 13, in the table T2B stored in the memory 13, the identification criteria may be modified in accordance with the difference h4 in humidity near the sheet material P detected by the detector 11. Therefore, with reference to the identification criteria of the table T2B, in which a difference h4 of approximately 2.6 g/m³ falls in a range greater than approximately 2.5 g/m³, the controller 15 identifies the corresponding sheet material P as plain paper and corrects the image forming conditions accordingly. Similarly, with reference to the identification criteria of the table T2B, in which a difference h4 of approximately 2.5 g/m³ falls in a range of from approximately 1.5 g/m³ to approximately 2.5 g/m³, the controller 15 identifies the corresponding sheet material P as special paper A and corrects the image forming conditions accordingly. Similarly, with reference to the identification criteria of the table T2B, in which a difference h4 of approximately 1.4 g/m³ falls in a range less than approximately 1.5 g/m³, the controller 15 identities the corresponding sheet material P as special paper B and corrects the image forming conditions accordingly.

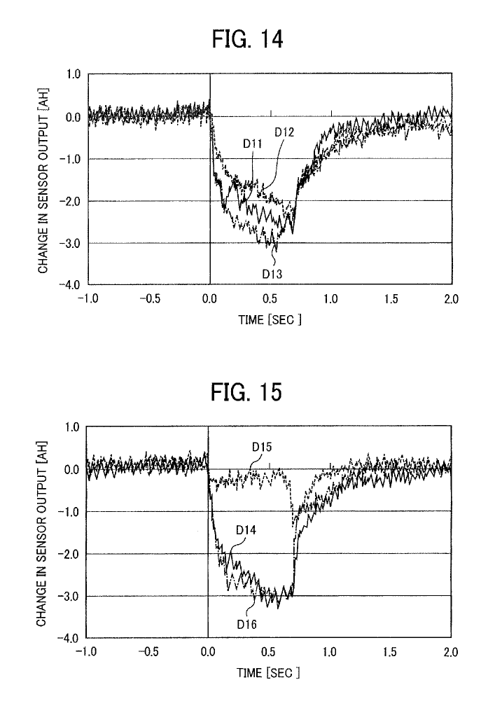

A third embodiment of the present invention will now be described. FIG. 14 is a graph illustrating the relationship between the time and the change in sensor output of the detector 11 in FIG. 3 when detecting different surfaces of a sheet material P of plain paper in the third embodiment. In FIG. 14, a sensor output D11 indicated by a solid line is the output of the detector 11 when detecting a surface of an A4-size sheet material P of plain paper not subjected to printing. A sensor output D12 indicated by a dashed line is the output of the detector 11 when detecting a printed surface of an A4-size sheet material P of plain paper. A sensor output D13 indicated by a dash-dotted line is the output of the detector 11 when detecting a rear surface of a printed surface of an A4-size sheet material P of plain paper (i.e., a surface not subjected to printing). As illustrated in FIG. 14, the sensor outputs D11, D12, and D13 are reduced after the arrival of the sheet material P at the humidity sensor 11B of the detector 11, i.e., the humidity is reduced. Thereafter, the sensor outputs D11, D12, and D13 return to the respective original values according to the humidity of the ambient environment.

FIG. 15 is a graph illustrating the relationship between the time and the change in sensor output of the detector 11 in FIG. 3 when detecting different surfaces of a sheet material P of special paper A in the third embodiment. In FIG. 15, a sensor output D14 indicated by a solid line is the output of the detector 11 when detecting a surface of an A4-size sheet material P of special paper A not subjected to printing. A sensor output D15 indicated by a dashed Line is the output of the detector 11 when detecting a printed surface of an A4-size sheet material P of special paper A. A sensor output D16 indicated by a dash-dotted line is the output of the detector 11 when detecting a rear surface of a printed surface of an A4-size sheet material P of special paper A (i.e., a surface not subjected to printing). As illustrated in FIG. 15, the sensor outputs D14 and D16 are reduced after the arrival of the sheet material P at the humidity sensor 11B, i.e., the humidity is reduced. Thereafter, the sensor outputs D14 and D16 return to the respective original values according to the humidity of the ambient environment. Meanwhile, the sensor output D15 is slightly reduced after the arrival of the sheet material P at the humidity sensor 11B but is higher than the sensor outputs D14 and D16, i.e., the humidity is reduced but higher than in the sensor outputs D14 and D16. Thereafter, the sensor output D15 returns to the original value according to the humidity of the ambient environment.

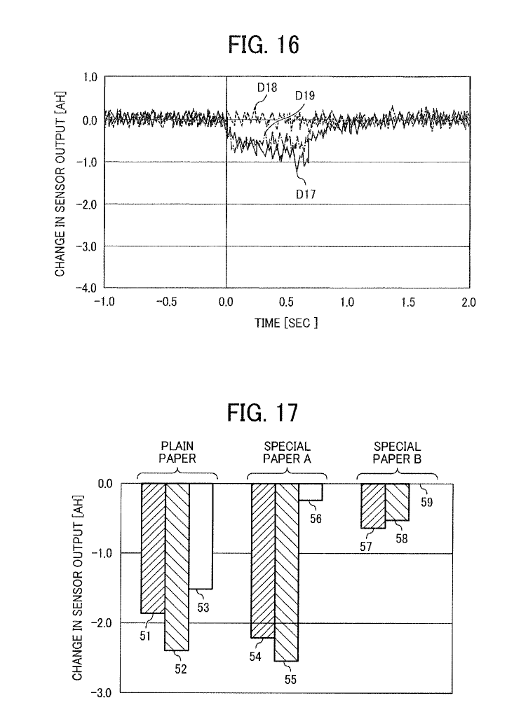

FIG. 16 is a graph illustrating the relationship between the time and the change in sensor output of the detector 11 in FIG. 3 when detecting different surfaces of a sheet material P of special paper B in the third embodiment. In FIG. 16, a sensor output D17 indicated by a solid line is the output of the detector 11 when detecting a surface of an A4-size sheet material P of special paper B not subjected to printing. A sensor output D18 indicated by a dashed line is the output of the detector 11 when detecting a printed surface of an A4-size sheet material P of special paper B. A sensor output D19 indicated by a dash-dotted line is the output of the detector 11 when detecting a rear surface of a printed surface of an A4-size sheet material P of special paper B (i.e., a surface not subjected to printing). As illustrated in FIG. 16, the sensor outputs D17 and D19 are reduced after the arrival of the sheet material P at the humidity sensor 11B, i.e., the humidity is reduced. Thereafter. the sensor outputs D17 and D19 return to the respective original values according to the humidity of the ambient environment. Meanwhile, the sensor output D18 is substantially unchanged after the arrival of the sheet material P at the humidity sensor 11B, and maintains the original value according to the humidity of the ambient environment. This is presumably because the absorption of moisture by the printed surface of the sheet material P of special paper B is substantially delayed by a toner layer formed on, for example, a coating layer of the sheet material P of special paper B.

FIG. 17 is a graph illustrating changes in sensor output of the detector 11 when detecting different surfaces of sheet materials P of plain paper, special paper A, and special paper B in the third embodiment. FIG. 17 illustrates respective outputs of the humidity sensor 11B of the detector 11 when detecting different surfaces of sheet materials P of plain paper, special paper A, and special paper B adjusted to humidity of approximately 11% RH in an environment with a temperature of approximately 23.8° C. and humidity of approximately 48% RH. As illustrated in FIG. 17, in the case of plain paper, the reduction in output of the detector 11 is the greatest in a rear surface 52 of a printed surface of a sheet material P, followed by a surface 51 of a sheet material P not subjected to printing, and then a printed surface 53 of a sheet material P. In the case of special paper A, the reduction in output of the detector 11 is the greatest in a rear surface 55 of a printed surface of a sheet material P, followed by a surface 54 of a sheet material P not subjected to printing, and then a printed surface 56 of a sheet material P. In the case of special paper B, the reduction in output of the detector 11 is the greatest in a surface 57 of a sheet material P not subjected to printing, followed by a rear surface 58 of a printed surface of a sheet material P, and then a printed surface 59 of a sheet material P (corresponding to an output of approximately zero volts).

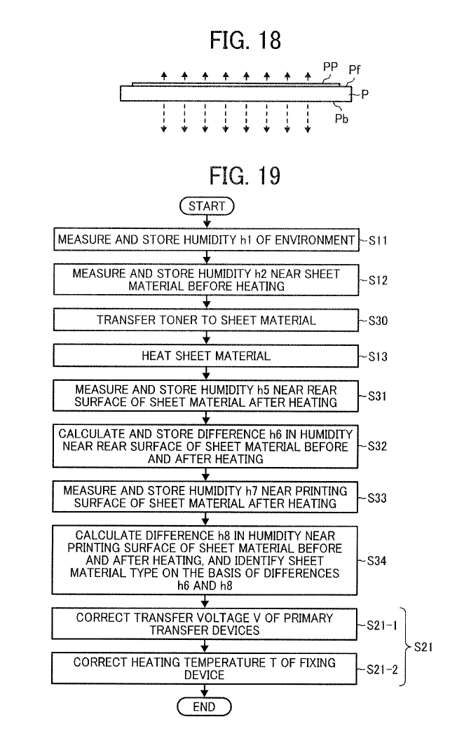

FIG. 18 is a diagram illustrating the change in humidity on the printed surface and the rear surface of the sheet material P in the third embodiment. As illustrated in FIG. 18, a print layer PP of toner and so forth is formed on a front surface Pf of the sheet material P but not on a rear surface Pb of the sheet material P. Due to the print layer PP of toner and so forth, therefore, the change in humidity is reduced on the front surface Pf of the sheet material P. Meanwhile, on the rear surface Pb of the sheet material P, the change in humidity is increased by the absence of the print layer PP of toner and so forth.

FIG. 19 is a flowchart illustrating a sheet material type identification process and an image forming condition correction process according to the third embodiment. As compared with the sheet material type identification process and the image forming condition correction process according to the second embodiment illustrated in FIG. 11, the third embodiment detects a difference h6 in humidity near the rear surface of the sheet material P before and after the heating and a difference h8 in humidity near the printing surface of the sheet material P before and after the heating (i.e., second difference), and identifies the type of sheet material P on the basis of the differences h6 and h8, as illustrated in FIG. 19.

At step S30 of FIG. 19, the controller 15 causes the primary transfer devices 6 and the secondary transfer device 41 to transfer toners to the sheet material P. At step S31, the controller 15 causes the detector 11 to measure humidity h5 near the rear surface of the printing surface of the sheet material P after heating and store the humidity h5 in the memory 13. At step S32, the controller 15 calculates the difference h6 in humidity near the rear surface of the sheet material P before and after the heating and stores the difference h6 in the memory 13. Specifically, the controller 15 calculates, as the difference h6 in humidity near the rear surface of the sheet material P before and after the heating, the difference between the humidity h2 and the humidity h5 stored in the memory 13.

Then, at step S33, the controller 15 causes the detector 11 to measure humidity h7 near the printing surface of the sheet material P after heating and store the humidity h7 in the memory 13. At step S34, the controller 15 calculates the difference h8 in humidity near the printing surface of the sheet material P before and after the heating and identifies the type of sheet material P on the basis of the differences h6 and h8. Specifically, the controller 15 calculates, as the difference h8 in humidity near the printing surface of the sheet material P before and after the heating, the difference between the humidity h2 and the humidity h7 stored in the memory 13. Then, the controller 15 identifies the type of sheet material P by referring to a predetermined table T3 and a table T3J of identification criteria for the table T3, which are stored in the memory 13.

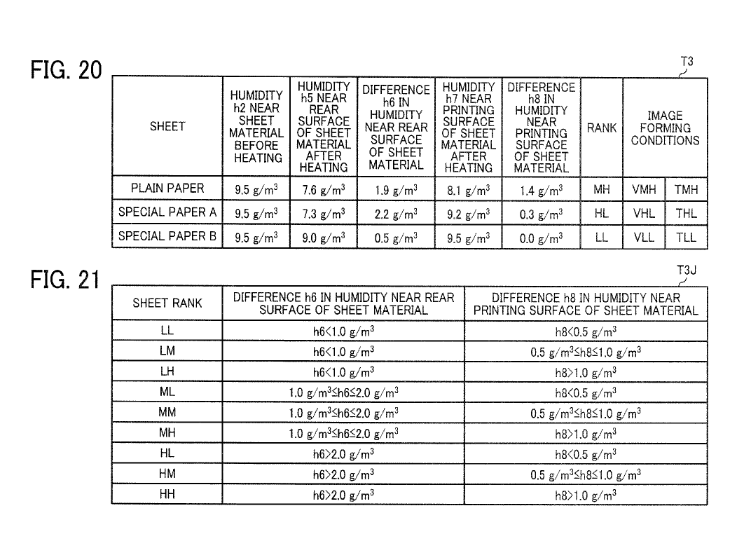

FIG. 20 is a diagram illustrating the table T3 for the sheet material type identification process according to the third embodiment stored in the memory 13 of FIG. 3. FIG. 21 is a diagram illustrating the table T3J of the identification criteria for the table T3. As illustrated in FIGS. 20 and 21, in the case of the sheet material P of plain paper, the difference h6 of the rear surface is approximately 1.9 g/m³, and the difference h8 of the printing surface is approximately 1.4 g/m³. With reference to the table T3J of the identification criteria for the table T3, in which the difference h6 falls in a range of from approximately 1.0 g/m³ to approximately 2.0 g/m³ and the difference h8 falls in a range greater than approximately 1.0 g/m³, the controller 15 identifies the sheet material P as plain paper corresponding to a sheet rank of MH.

Similarly, as illustrated in FIGS. 20 and 21, in the case of the sheet material P of special paper A, the difference h6 of the rear surface is approximately 2.2 g/m³, and the difference h8 of the printing surface is approximately 0.3 g/m³. With reference to the table T3J of the identification criteria for the table T3, in which the difference h6 falls in a range greater than approximately 2.0 g/m³ and the difference h8 falls in a range less than approximately 0.5 g/m³, the controller 15 identifies the sheet material P as special paper corresponding to a sheet rank of HL. Similarly, as illustrated in FIGS. 20 and 21, in the case of the sheet material P of special paper B, the difference h6 of the rear surface is approximately 0.5 g/m³, and the difference h8 of the printing surface is approximately 0.0 g/m³. With reference to the table T3J of the identification criteria for the table T3, in which the difference h6 falls in a range less than approximately 1.0 g/m³ and the difference h8 falls in a range less than approximately 0.5 g/m³, the controller 15 identifies the sheet material P as special paper corresponding to a sheet rank of LL.

Returning to step S21 of FIG. 19, the controller 15 causes the image forming condition controller 14 to similarly correct the transfer voltage V of the primary transfer devices 6 and the heating temperature T of the fixing device 8 on the basis of the identified type of the sheet material P.

As described above, according to the sheet material type identification process and the image forming condition correction process executed by the sheet material identification device 100 according to the third embodiment, the difference h6 in humidity near the rear surface of the sheet material P before and after the heating and the difference h8 in humidity near the printing surface of the sheet material P before and after the heating are detected, and the type of sheet material P is identified on the basis of the differences h6 and h8.

Accordingly, the type of sheet material P is identified in more detail, and the image forming conditions are controlled on the basis of the identified type of the sheet material P. For example, according to the third embodiment, the rank of the sheet material P may be divided into nine ranks of LL, LM, LH, ML, MM, MH, HL, HM, and HH, as illustrated in FIG. 21, to thereby control the image forming conditions on the basis of the identified rank of the sheet material P corresponding to one of the ranks of LL to HH.

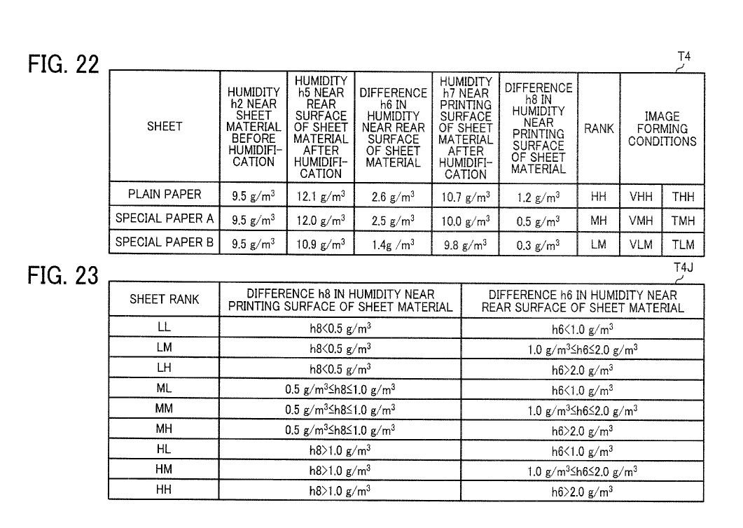

FIG. 22 is a diagram illustrating a table T4 for a sheet material type identification process and an image forming condition correction process executed by the sheet material identification device 100 according to a modified example of the third embodiment. FIG. 23 is a diagram illustrating a table T4J of identification criteria for the table T4. As illustrated in FIG. 22, in the case of the sheet material P of plain paper, the difference h6 of the rear surface is approximately 2.6 g/m³, and the difference h8 of the printing surface is approximately 1.2 g/m³. With reference to the table T4J of the identification criteria for the table T4, in which the difference h6 falls in a range greater than approximately 2.0 g/m³ and the difference h8 falls in a range greater than approximately 1.0 g/m³, the controller 15 identifies the sheet material P as plain paper corresponding to a sheet rank of HH.

Similarly, as illustrated in FIG. 22, in the case of the sheet material P of special paper A, the difference h6 of the rear surface is approximately 2.5 g/m³, and the difference h8 of the printing surface is approximately 0.5 g/m³. With reference to the table T4J of the identification criteria for the table T4, in which the difference h6 falls in a range greater than approximately 2.0 g/m³ and the difference h8 falls in a range of from approximately 0.5 g/m³ to approximately 1.0 g/m³, the controller 15 identifies the sheet material P as special paper A corresponding to a sheet rank of MH. Similarly, as illustrated in FIG. 22, in the case of the sheet material P of special paper B, the difference h6 of the rear surface is approximately 1.4 g/m³, and the difference h8 of the printing surface is approximately 0.3 g/m³. With reference to the table T4J of the identification criteria for the table T4, in which the difference h6 falls in a range of from approximately 1.0 g/m³ to approximately 2.0 g/m³ and the difference h8 falls in a range less than approximately 0.5 g/m³, the controller 15 identifies the sheet material P as special paper B corresponding to a sheet rank of LM. The tables and identification criteria stored in the memory 13 may thus he modified as necessary,

According to the configurations of the above-described embodiments, the type of sheet material is accurately identified.

The above-described embodiments and effects thereof are illustrative only and do not limit the present invention. Thus, numerous additional modifications and variations are possible in light of the above teachings. For example, elements or features of different illustrative embodiments herein may be combined with or substituted for each other within the scope of this disclosure and the appended claims. Further, features of components of the embodiments, such as number, position, and shape, are not limited to those of the disclosed embodiments and thus may be set as preferred. Further, the above-described steps are not limited to the order disclosed herein. It is therefore to be understood that, within the scope of the appended claims, the disclosure of the present invention may he practiced otherwise than as specifically described herein.

What is claimed is:

1. A sheet material identification device comprising:
a humidity adjuster configured to adjust the humidity of a sheet material by causing the sheet material to either release or absorb moisture;
a detector configured to detect the humidity of the sheet material before and after the adjustment of the humidity; and
a controller configured to calculate a first difference in humidity of the sheet material before and after the adjustment of the humidity, and identify the type of sheet material on the basis of the first difference.

2. The sheet material identification device according to claim 1, wherein the detector detects the humidity of a printing surface of the sheet material before and after the adjustment of the humidity, and
wherein the controller calculates a second difference in humidity of the printing surface before and after the adjustment of the humidity, and identifies the type of sheet material on the basis of the first and second differences.

3. The sheet material identification device according to claim 1, wherein the humidity adjuster includes a heater configured to heat the sheet material to cause the sheet material to release moisture.

4. The sheet material identification device according to claim 1, wherein the humidity adjuster includes a drier configured to dry the sheet material to cause the sheet material to release moisture.

5. The sheet material identification device according to claim 1, wherein the humidity adjuster includes a humidifier configured to humidify the sheet material to cause the sheet material to absorb moisture.

6. The sheet material identification device according to claim 1, further comprising:
a memory configured to store a first table of identification criteria for identifying the type of sheet material corresponding to the first difference,
wherein the controller identifies the type of sheet material on the basis of the first difference with reference to the first table.

7. The sheet material identification device according to claim 6, wherein the first table includes correction information for correcting image forming conditions of an image forming apparatus that forms an image on the sheet material, and
wherein the controller controls the image forming apparatus on the basis of the correction information of the first table for correcting the image forming conditions for forming an image on the identified sheet material.

8. The sheet material identification device according to claim 2, further comprising:
a memory configured to store a second table of identification criteria for identifying the type of sheet material corresponding to the first and second differences,
wherein the controller identifies the type of sheet material on the basis of the first and second differences with reference to the second table.

9. The sheet material identification device according to claim 8, wherein the second table includes correction information for correcting image forming conditions of an image forming apparatus that forms an image on the sheet material, and
wherein the controller controls the image forming apparatus on the basis of the correction information of the second table for correcting the image forming conditions for forming an image on the identified sheet material.

10. An image forming apparatus comprising:
an image forming mechanism configured to form an image on a sheet material; and
a sheet material identification device including:
a humidity adjuster configured to adjust the humidity of the sheet material by causing the sheet material to either release or absorb moisture,
a detector configured to detect the humidity of the sheet material before and after the adjustment of the humidity, and
a controller configured to calculate a first difference in humidity of the sheet material before and after the adjustment of the humidity, and identify the type of sheet material on the basis of the first difference.

11. A sheet material identification method comprising:
adjusting the humidity of a sheet material by causing the sheet material to either release or absorb moisture;
detecting the humidity of the sheet material before and after the adjustment of the humidity;
calculating a first difference in humidity of the sheet material before and after the adjustment of the humidity; and
identifying the type of sheet material on the basis of the first difference.

12. The sheet material identification method according to claim 11, wherein the detecting detects the humidity of a printing surface of the sheet material before and after the adjustment of the humidity, and
wherein the calculating calculates a second difference in humidity of the printing surface before and after the adjustment of the humidity, and
wherein the identifying identifies the type of sheet material on the basis of the first and second differences.
